(19) United States
(12) Patent Application Publication
(10) Pub. No.: US 2026/0262807 A1
(43) Pub. Date: Sep. 10, 2026

(54) COMPOSITE STRINGER AND METHOD FOR PRODUCING SAME

(71) Applicant: YKK Corporation, Chiyoda-ku, Tokyo (JP)

(72) Inventors: Zhiyu REN, Toyama (JP); Atsushi NAKAYA, Toyama (JP)

(21) Appl. No.: 18/728,853

(22) PCT Filed: Mar. 3, 2022
(86) PCT No.: PCT/JP2022/009224

§ 371 Date: May 15, 2026

(51) Int. Cl. A44B 19/52; A44B 19/06

(52) U.S. Cl. CPC A44B 19/52; A44B 19/06

(57) ABSTRACT

A method of producing a composite stringer (2) includes: supplying a soft or molten resin (1) onto a circumferential surface of a die wheel (10); and feeding at least one sheet member (9) onto the circumferential surface of the die wheel (10) simultaneously as said supplying of the resin (1) onto the circumferential surface of die wheel (10). The at least one sheet member (9) is fed onto the circumferential surface of the die wheel (10) so as to overlap at least partially the respective ones of the first and second molding belts (10a, 10b) and to cross a boundary between the first and second molding belts (10a, 10b) so that the composite stringer (2) has a surface condition or appearance in accordance with the sheet member (9) on both sides of the boundary between the tape portion (3) and the fastening portion (4). Note that the first molding belt (10a) is adapted to mold a fastening portion (4) including at least plural fastening elements (5). The second molding belt (10b) is adapted to mold or form the tape portion (3).

### TECHNICAL FIELD

The present disclosure is related to a composite stringer and a method of producing the same.

### BACKGROUND ART

PTL 1 discloses that fastening devices are produced by the use of extrusion molding in replacement of injection molding. The same literature faces a technical problem of non-flexibility and/or weakness of a fastening portion when the extrusion molding is employed, and clearance grooves are employed for a purpose of addressing the problem. Furthermore, FIG. 23 of the same literature discloses that a supplemental tape is secured onto a tape portion of the fastening device. With respect to a way of securement of the supplemental tape, paragraph 0047 of the same literature suggests “processes such as insert-molding, simultaneous extrusion, welding, bonding, sewing or other chemical or mechanical bondings”.

PTL 2 relates to another type of fastening device (i.e. a surface fastener) than the PTL1, and discloses that additionally to a resin, a sheet member (e.g. nonwoven fabric, woven fabric, knitted fabric, polyurethane foam, plastic film, paper) is fed onto a surface of roller.

### CITATION LIST

### Patent Literature

[PTL 1] International Publication No. 2019/039388

[PTL 2] Japanese Patent No.3,673,811

### SUMMARY

### Technical Problem

In a case of FIG. 23 of PTL1, the sheet member is arranged selectively on the tape portion of composite stringer in view of potential influence on molding of fastening elements and/or fastening portion. However, in this case, with respect to a boundary between the fastening portion and the tape portion, a difference in characteristic of composite stringer (e.g. one or more characteristics selected from a group consisting of external appearance, surface condition, flexibility and mechanical strength) may be caused between one and the other sides of the boundary. As such, the present inventors have newly discovered a technical challenge inherent in the conventional method of the selective arrangement of the sheet member on the tape portion of composite stringer.

### Solution to Problem

A method of producing a composite stringer according to an aspect of the present disclosure relates to a method of producing a composite stringer including at least a tape portion and a fastening portion, the method including:

supplying a soft or molten resin onto a circumferential surface of a die wheel, the circumferential surface of the die wheel including first and second molding belts adjacent in a width direction of the die wheel and extending in a circumferential direction of the die wheel, the first molding belt being adapted to mold a fastening portion including at least plural fastening elements, the second molding belt being adapted to mold or form the tape portion; and feeding at least one sheet member onto the circumferential surface of the die wheel simultaneously as said supplying of the resin onto the circumferential surface of die wheel, the sheet member being fed onto the circumferential surface of the die wheel so as to overlap at least partially the respective ones of the first and second molding belts and to cross a boundary between the first and second molding belts so that the composite stringer has a surface condition or appearance in accordance with the sheet member on both sides of the boundary between the tape portion and the fastening portion.

In some embodiments, the resin and the sheet member are supplied into an interspace between a pair of die wheels including said die wheel as a first die wheel.

In some embodiments, a circumferential surface of a second die wheel of the pair of die wheels includes a third molding belt adapted to mold the fastening portion together with the first molding belt of the first die wheel.

In some embodiments, the sheet member is made of porous material allowing penetration or permeation of the resin through the at least one sheet member, allowing the resin to flow between the first molding belt and the third molding belt.

In some embodiments, the sheet member has a width equal to or wider than a In some embodiments, the resin and the sheet member are supplied onto the circumferential surface of the die wheel so as to allow a structure of the sheet member to be observable in one or both of top and bottom faces or a side face of the composite stringer.

In some embodiments, the resin and the sheet member are supplied onto the circumferential surface of the die wheel so that: (i) a first region of the sheet member is enclosed at least partially in a resin layer of the tape portion, or a first region of the sheet member is impregnated with a resin of the tape portion, or a first region of the sheet member is laminated to a resin layer of the tape portion; and (ii) a second region of the sheet member or a broken piece of the sheet member is at least partially enclosed in a resin portion of the fastening portion, or a second region of the sheet member or a broken piece of the sheet member is impregnated with a resin of the fastening portion, or a second region of the sheet member or a broken piece of the sheet member is laminated to a resin portion of the fastening portion.

In some embodiments, the composite stringer has a pair of side-edge portions extending along its elongation direction, and the resin and the sheet member are supplied onto the circumferential surface of the die wheel so as to allow at least one of the pair of side-edge portions to have a surface condition or appearance in accordance with the sheet member.

In some embodiments, the circumferential surface of the die wheel include a first belt including the first molding belt and the second molding belt, and a second belt including a further first molding belt and a further second molding belt, the further first molding belt having a molding surface configured identical to the first molding belt, the further second molding belt having a molding surface configured identical to the second molding belt. The method of producing a composite stringer may further include separating a first composite stringer molded in the first belt and a second composite stringer molded in the second belt.

A composite stringer according to another aspect of the present disclosure includes: a tape portion; a fastening portion; and at least one sheet member, wherein each of the tape portion, the fastening portion and the sheet member extend in an elongation direction of the composite stringer, and the tape portion and the fastening portion are arranged adjacently, and wherein the sheet member is included in respective ones of the tape portion and the fastening portion, and the composite stringer has a surface condition or appearance in accordance with the sheet member on both sides of a boundary between the tape portion and the fastening portion.

In some embodiments, a first region of the sheet member is enclosed at least partially in a resin layer of the tape portion, or a first region of the sheet member is impregnated with a resin of the tape portion, or a first region of the sheet member is laminated to a resin layer of the tape portion.

In some embodiments, at least a part of a second region of the sheet member or a broken piece of the sheet member is enclosed in a resin portion of the fastening portion, or a second region of the sheet member or a broken piece of the sheet member is impregnated with a resin of the fastening portion, or a second region of the sheet member or a broken piece of the sheet member is laminated to a resin portion of the fastening portion.

In some embodiments, a part of the second region of the sheet member is positioned in a side-edge portion of the fastening portion distal to the tape portion.

In some embodiments, the fastening portion encloses a part of the sheet member or a broken piece of the sheet member; and/or a structure of the sheet member is observable in one or both of top and bottom faces or a side face of the composite stringer.

In some embodiments, the fastening portion includes a groove extending in the elongation direction so as to form a box portion on a side of one tape face of the tape portion, and a series of fastening elements in which the fastening elements are arranged on a bottom surface of the groove along the elongation direction and gaps are formed between adjacent fastening elements, each fastening element including a stem standing on the bottom surface of the groove along a thickness direction of the tape portion and an engagement protrusion protruding from the stem in the elongation direction.

### Advantageous Effects of Invention

According to an aspect of the present disclosure, it may be suppressed that with respect to a boundary between a fastening portion and a tape portion, it may be suppressed that a difference in characteristic of composite stringer (e.g. one or more characteristics selected from a group consisting of external appearance, surface condition, flexibility and mechanical strength) is caused between one and the other sides of the boundary.

### BRIEF DESCRIPTION OF DRAWINGS

FIG. 1 is a schematic perspective view of a pair of composite stringers in decoupled state according to an aspect of the present disclosure, depicting first face of one composite stringer and second face of the other composite stringer.

FIG. 2 is a schematic perspective view of a pair of composite stringer in coupled state.

FIG. 3 is a schematic view of a composite stringer in cross section taken along a width direction thereof.

FIG. 4 is a schematic view of a composite stringer in cross section taken along an elongation direction thereof.

FIG. 5 is a schematic view depicting an engaged state of respective fastening portions (fastening elements) in a pair of composite stringers, and also depicting a slider used for engaging and disengaging the fastening portions.

FIG. 6 is a schematic perspective view depicting an apparatus for production of composite stringer.

FIG. 7 is a schematic side view depicting an apparatus for production of composite stringer.

FIG. 8 is an elevation view of a primary molded part produced by the production apparatus.

FIG. 9 is a schematic view of the primary molded part in cross section taken along its width direction.

FIG. 10 is a schematic cross-sectional view depicting arrangement of circumferential surfaces of first and second die wheels.

FIG. 11 is another schematic cross-sectional view depicting arrangement of circumferential surfaces of first and second die wheels.

FIG. 12 is a schematic view depicting arrangement of circumferential surfaces of first and second die wheels in cross section taken along a circumferential direction.

FIG. 13 is a schematic partial elevation view of a second face of a primary molded part.

FIG. 14 is a schematic process diagram illustrating a process of dividing the primary molded part.

FIG. 15 is a schematic process diagram illustrating that a pair of composite stringers is produced by dividing the primary molded part produced.

FIG. 16 is a schematic view depicting a variation of apparatus for producing a composite stringer.

FIG. 17 is a schematic view depicting a variation of apparatus for producing a composite stringer.

FIG. 18 is a schematic view depicting a variation of apparatus for producing a composite stringer.

FIG. 19 is a schematic view depicting a variation of cross-sectional configuration of a composite stringer.

FIG. 20 is a photograph of first face of composite stringer according to working example.

FIG. 21 is a photograph of second face of composite stringer according to working example.

FIG. 22 is a photograph of a slide fastener including an assembled pair of composite stringers according to working example.

FIG. 23 is a schematic view depicting a primary molded part 8 according to another example produced by a method that follows a method shown in FIG. 17.

### DESCRIPTION OF EMBODIMENTS

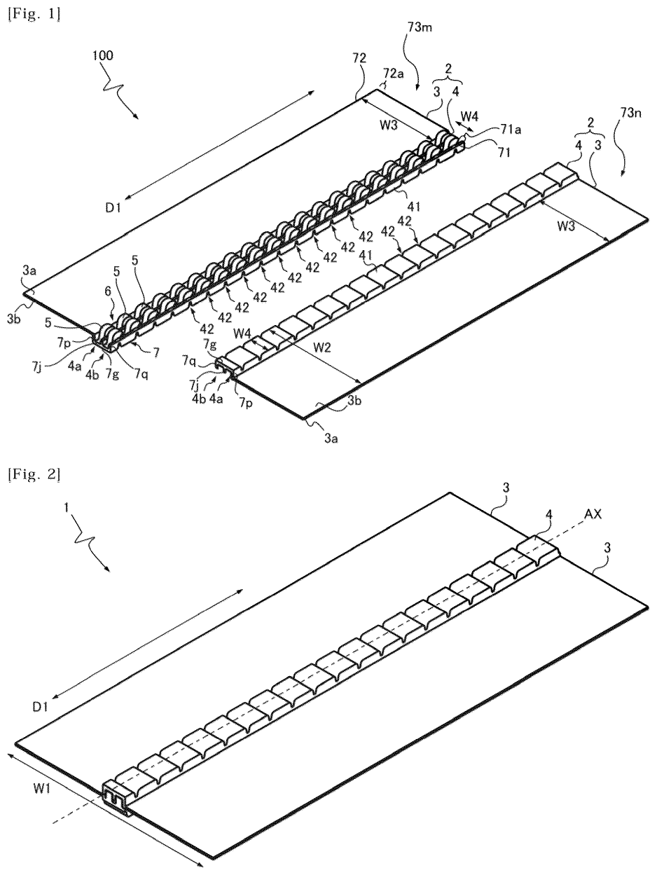

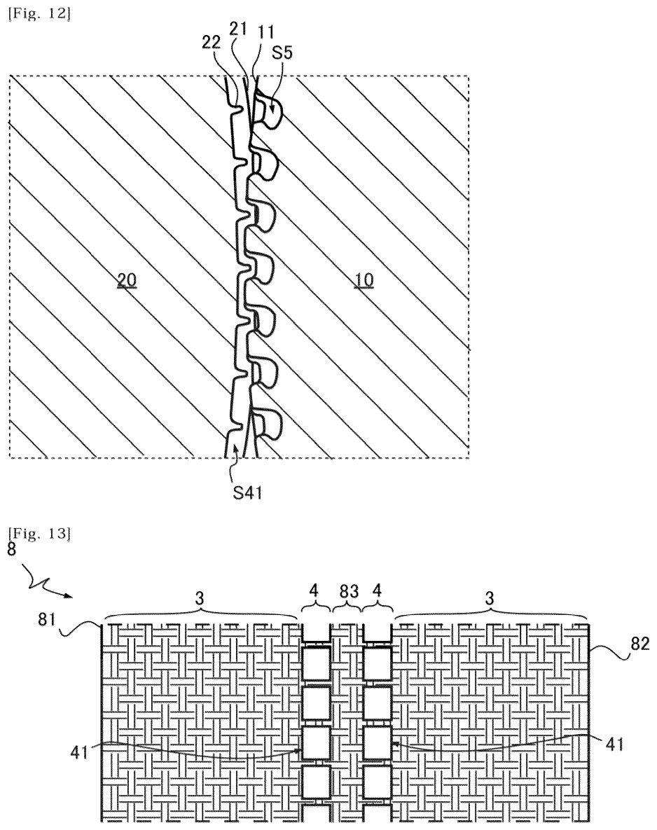

Hereinafter, various embodiments and features would be discussed with reference to FIGS. 1-23. A skilled person would be able to combine respective embodiments and/or respective features without requiring excess description, and would appreciate synergistic effects of such combinations. Overlapping description among the embodiments are basically omitted. Referenced drawings aim mainly for describing inventions and are simplified for the sake of convenience of drawing preparation. The respective features should be appreciated as universal features not only effective to composite stringers and methods of producing the same presently disclosed but also effective to other various composite stringers and methods of producing the same not disclosed in the present specification.

In the present specification, directions may be defined based on a central line AX (See FIG. 2) of fastening device 100. For clearer description, we define a direction on or in parallel to the central line AX as front-rear direction; a direction orthogonal to the central line AX and parallel to a width direction of fastening device 100 as left-right direction; and a direction orthogonal to the above-defined directions as up-down direction. Directions may be referred which are differently defined from the above ones. For example, the front-rear direction and elongation direction may be replaceable. The left-right direction and the width direction may be replaceable. The up-down direction and the thickness direction may be replaceable.

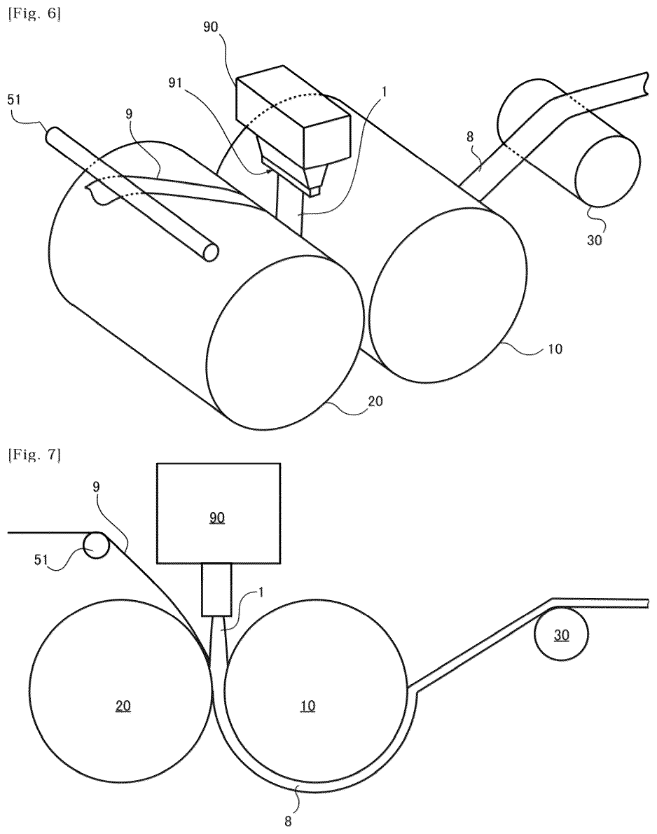

As illustrated in FIGS. 1 and 2, the fastening device 100 has a pair of composite stringers 2 and an optional slider 200 (See FIG. 5). The fastening device 100 is an elongated implement that extends, in a condition the composite stringers 2 are partially stacked and coupled, in the elongation direction D1 with a predetermined width W1. In the condition, the fastening device 100 has a flexibility and is bendable and flexible along its central line AX. Each composite stringer 2 is an elongated part that extends along the elongation direction D1 with a predetermined width W2. The composite stringer 2 has a flexibility and is therefore bendable and flexible in a width direction (a direction of double-headed arrow labelled with W1 in FIG. 2) and an elongation direction D1 (a direction of double-headed arrow labelled with D1 in FIGS. 1 and 2).

The fastening device 100 is attached to an article such as clothes, shoes, bags, suitcase or the like to effect opening and closing of the article. In particular, the composite stringers 2 of the fastening device 100 are secured to different portions of the article, allowing the different portions of the article to be coupled and decoupled based on coupling and decoupling of the respective composite stringers 2. The composite stringer 2 may be secured to a portion of the article by any method (e.g. sewing, adhering, and melting for attachment or a combination thereof). Note that the fastening device 100 may include the slider 200 for smooth coupling and decoupling of the composite stringers 2 one another, but the slider 200 may be omitted. The composite stringers 2 may be coupled and decoupled one another as operated by human hand without using the slider 200.

Each composite stringer 2 includes a tape portion 3 and a fastening portion 4 which are elongated in the front-rear direction and are arranged adjacently in the left-right direction. The tape portion 3 and the fastening portion 4 have certain widths W3 and W4 respectively, typically W3>W4 satisfied. The tape portion 3 and the fastening portion 4 extend continuously in the front-rear direction, allowing the use of combination of extruder and die wheel molding for a purpose of molding the tape portion 3 and the fastening portion 4. Thus, efficiency of production would be enhanced and simultaneously reduction of cost would be facilitated, compared with a slide fastener in which respective resin-made elements are formed through injection molding. With respect to a type of slide fastener in which resin-made elements are formed through injection molding, a process for producing a fastener tape and a process of injection molding of the elements to the fastener tape are performed separately in general, and simultaneous production is not possible.

The respective composite stringer 2 has, in its width direction, a first side edge 71 and a second side edge 72 opposite to the first side edge 71, and further has a first side edge portion 71a located nearby the first side edge 71 and a second side edge portion 72a located nearby the second side edge 72. Note that, the first side edge portion 71a is a side-edge portion of the fastening portion 4 located away from the tape portion 3. The second side edge portion 72a is a side-edge portion of the tape portion 3 located away from the fastening portion 4. In the fastening device 100, the first side edge 71 of the left-side composite stringer 2 is laid on the right-side composite stringer 2 in the up-down direction and similarly, the first side edge 71 of the right-side composite stringer 2 is laid on the left-side composite stringer 2 in the up-down direction.

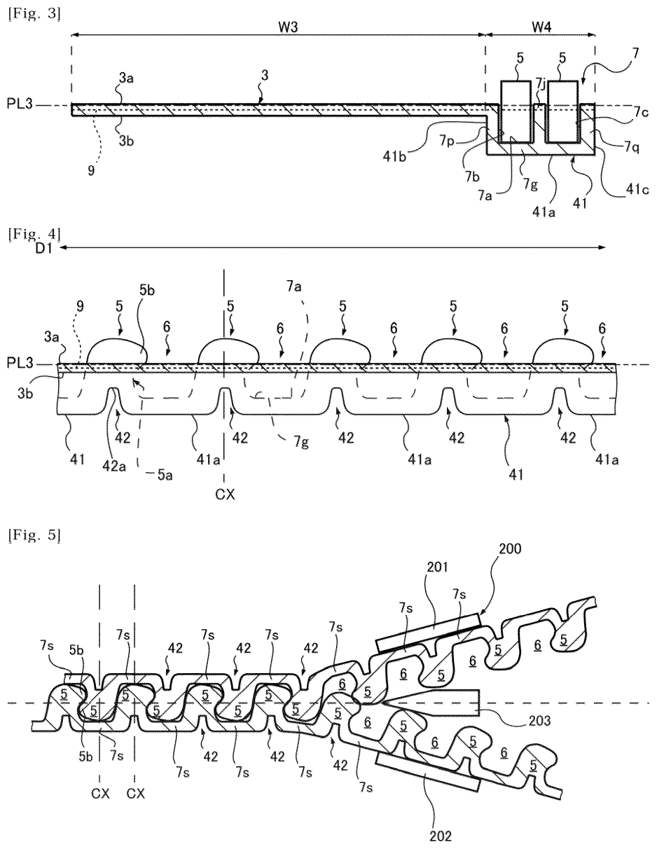

The respective composite stringer 2 has a first face 73m and a second face 73n as one and the other faces. The respective composite stringer 2 is a composite part of a sheet member 9 (illustrated as a dotted line in FIGS. 3 and 4) and a resin, and has a surface condition or appearance in accordance with the sheet member 9. In particular, the composite stringer 2 has a surface condition or appearance in accordance with the sheet member 9 on both sides of a boundary between the tape portion 3 and the fastening portion 4. Accordingly, with respect to the boundary between the fastening portion and the tape portion, the composite stringer is prevented from having different characteristic(s) (e.g. one or more characteristics selected from a group consisting of appearance, surface condition, softness and mechanical strength) between one and the other sides of the boundary. Note that, the surface condition and appearance of the composite stringer 2 may be observed as a pattern, unevenness, reflectivity and the like of the surface. The surface condition and appearance of the composite stringer 2 may be observed on one or both of top and bottom faces of the composite stringer 2, i.e. the above-noted first face 73m and/or the second face 72n. Additionally or alternatively, the surface condition and appearance of the composite stringer 2 may be observable on a side face of the composite stringer 2. Note that, the composite stringer 2 typically has four side faces defining its contour, with two side faces thereof extending in parallel to the elongation direction of the composite stringer 2 and the remaining two side faces extending in parallel to the width direction of the composite stringer 2, not limited to this though.

The tape portion 3 has a first tape face 3a on the same side as the first face 73m of the composite stringer 2, and a second tape face 3b on the same side as the second face 73n of the composite stringer 2, and a thickness thereof is defined by the first and second tape faces 3a and 3b. The fastening portion 4 includes plural fastening elements 5 arranged at predetermined pitch in the front-rear direction on the side of the first face 73m of the composite stringer 2, and gaps 6 are formed between the adjacent fastening elements 5 in the front-rear direction. Two or more arrays 4a, 4b of fastening elements 5 may be arranged in the fastening portion 4 for a purpose of impeding fluid (e.g. water) flow through a space possibly caused between the engaged fastening portions 4 of the left and right composite stringers 2 and/or for a purpose of achieving a demanded engagement strength, but should not be limited to this. In another embodiment, a single array of fastening elements 5 is arranged in the fastening portion 4.

As illustrated in FIGS. 3 and 4, the fastening portion 4 has a groove 7 recessed from the first tape face 3a in a depth direction that matches the thickness direction of the tape portion 3. The groove 7 is open in the first face 73m and forms a box portion 41 protruding from the second tape face 3b in the second face 73n. The groove 7 and the box portion 41 each extends in the front-rear direction. Each fastening element 5 sits on the bottom surface of the groove 7 and/or is partially accommodated in the groove 7. The fastening elements 5 are arranged in the groove 7, thus reducing a thickness of the fastening portions 4 when the composite stringers 2 are coupled.

The groove 7 has sidewall plates 7p,7q arranged apart and opposed one another in the left-right direction (width direction) and a bottom plate 7g that interconnects the sidewall plates 7p,7q. The sidewall plates 7p, 7q extend in the depth direction of the groove 7 to define a depth of the groove 7. The sidewall plates 7p, 7q are positioned at the both edges of the bottom plate 7g in the left-right direction. A bottom end (also referred to as one end) of the sidewall plate 7p is connected to the edge of the bottom plate 7g, and a top end (also referred to as the other end) of the sidewall plate 7p is connected to the edge of the tape portion 3. A bottom end of the sidewall plate 7q is connected to the edge of the bottom plate 7g, and a top end of the sidewall plate 7q is a free end at the open side of the groove 7. The both top ends of the sidewall plate 7p and 7q may be positioned at the same height as the first tape face 3a. Note that the groove 7 may be omitted and the fastening elements 5 may be arranged on a plane coplanar to the first tape face 3a of the tape portion 3. In this case, the box portion 41 is not formed and this could be a flat surface. In cases where plural arrays 4a, 4b of the fastening elements 5 are arranged, the groove 7 may include a partition wall 7j for a purpose of preventing incorrect engagement of the fastening elements 5 of the respective arrays 4a,4b and/or for a purpose of impeding fluid flow through the engaged composite stringers 2.

At the side of the first face 73m and/or the first tape face 3a, the groove 7 has a bottom surface 7a and sidewall surfaces 7b,7c standing at the both edges of the bottom surface 7a in the width direction. The fastening element(s) 5 is interposed between the sidewall surfaces 7b,7c. The groove 7 is arranged to form the box portion 41 at the side of the second face 73n and/or the second tape face 3b. The box portion 41 has a main surface 41a and sidewall surfaces 41b, 41c standing at the both edges of the main surface 41a in the width direction. The above-noted bottom plate 7g has (or is defined by) the bottom surface 7a and the main surface 41a, the sidewall plate 7p has (or is defined by) the sidewall surface 7b and the sidewall surface 41b, and the sidewall plate 7q has (or is defined by) the sidewall surface 7c and the sidewall surface 41c.

As illustrated in FIG. 4, each fastening element 5 includes a stem 5a standing in the thickness direction of the tape portion 3 (i.e. a direction orthogonal to the first and second tape faces 3a,3b), and an engagement protrusion 5b protruding from the stem 5a in the elongation direction D1 (i.e. forward or rearward). The gap 6 between adjacent fastening elements 5 is adapted to receive the fastening element 5 of engagement partner, i.e. is shaped to have a space for receiving the stem and a space for receiving the engagement protrusion. Note that, the protruding direction of engagement protrusion 5b of fastening element 5 may be altered between the arrays 4a,4b of the fastening elements 5.

In an example of FIG. 5, the engagement protrusion 5b of the top-side composite stringer 2 protrudes rearward (in a direction of decoupling the composite stringers 2) from the stem 5a along the central line AX, and a smooth slope is formed on the front side of the stem 5a where no protrusion for engagement is formed. On the other hand, the engagement protrusion 5b of the bottom-side composite stringer 2 protrudes forward (in a direction of coupling the composite stringers 2) from the stem 5a along the central line AX, and a smooth slope is formed on the rear side of the stem 5a where no protrusion for engagement is formed.

In cases where the fastening elements 5 are arranged on the bottom surface of the groove 7, the stem 5a is arranged to stand on that bottom surface, and the engagement protrusion 5b protrudes from the stem 5a (e.g. from its terminal portion) along that bottom surface. The engagement protrusion 5b is located higher than the tape portion 3 from the bottom surface of the groove 7. A notch is formed between the engagement protrusion 5b and the bottom surface of the groove 7 to which the engagement protrusion 5b of the fastening element 5 of engaging partner is fitted. Note that the fastening element 5 is arranged to have a clearance with the sidewall surface 7b,7c of the groove 7, thus ensuring smooth deformation of the fastening element 5.

On the second face 73n of the composite stringer 2, the above-noted box portion 41 may have clearance grooves 42 which are formed at pitch interval equal to the pitch interval of the stems 5a of the fastening elements 5. The clearance groove 42 is positioned on the central line CX of the stem 5a of the fastening element 5, and is recessed along the central line CX in the same direction as the stem 5a protrudes. Note that the pitch interval of the stem 5a is equal to interspace between the central lines CX of the respective stems 5a. In such a case where the clearance grooves 42 are formed on the box portion 41, the fastening element 5 would have much enhanced deformability, facilitating easier engagement of the fastening elements 5 one another. Also the fastening portion 4 is allowed to more smoothly flex toward the top and bottom sides. Number of the clearance grooves 42 is preferably equal to number of the fastening elements 5, but not necessarily limited to this. Depth of the clearance groove 42 may be adjusted as desired. In some cases, the bottom surface 42a of the clearance groove 42 is positioned closer to a plane PL3 (See FIG. 3) where the tape portion 3 is placed than a bottom surface 7a of the groove 7. The clearance groove 42 may have a depth that crosses through the bottom plate 7g of the groove 7 and reaches the base portion of the stem 5a.

The composite stringers 2 are coupled while the fastening portions 4 of the respective composite stringers 2 are being stacked. For example, the left and right composite stringer 2 are stacked in the up-down direction in their fastening portions 4, and the top-side and bottom-side fastening portions 4 are engaged as nipping force is applied by fingers or slider. As illustrated in FIG. 5, entry of the fastening element 5 of the left (first) composite stringer 2 into the gap 6 between the fastening elements 5 of the right (second) composite stringer 2 and entry of the fastening element 5 of the right (second) composite stringer 2 into the gap 6 between the fastening elements 5 of the left (first) composite stringer 2 are alternately repeated, and the fastening portions 4 are engaged one another along the elongation direction D1 based on the above-noted mutual engagements of the fastening elements 5. Disengagement between the fastening portions 4 and disengagement between the fastening elements 5 would be similarly understandable.

In cases where a slider 200 is used, the slider 200 has a first wing 201, a second wing 202, and a coupling pillar 203 between the wings. For example, a passage for one of the left and right composite stringers 2 is defined between the first wing 201 and the coupling pillar 203. A passage for the other one of the left and right composite stringers 2 is defined between the second wing 202 and the coupling pillar 203. The first wing 201 and the coupling pillar 203 are connected by a sidewall plate not-illustrated at a side where it does not interfere with the tape portion 3 of the composite stringer 2. The same holds true to the second wing 202 and the coupling pillar 203. Typically, the slider 200 has S-shaped cross section.

In the present embodiment, the composite stringer 2 includes at least one sheet member 9. In particular, the sheet member 9 is included in the respective ones of the tape portion 3 and the fastening portion 4 of the composite stringer 2 (e.g. it is arranged to cross a boundary between the tape portion 3 and the fastening portion 4 so as to effect such a condition). Furthermore, the composite stringer 2 has a surface condition or appearance in accordance with the sheet member 9 on the both sides of the boundary between the tape portion 3 and the fastening portion 4. Accordingly, with respect to the boundary between the fastening portion and the tape portion, the composite stringer is prevented from having different characteristic(s) (e.g. one or more characteristics selected from a group consisting of appearance, surface condition, softness and mechanical strength) between one and the other sides of the boundary. In cases where the sheet member 9 is not made of resin, the composite stringer 2 would be more easily sewn to an article such as clothes and bag and the like, thus avoiding cost and process burden for attachment of a sheet which is for preventing cracks, for example. If it is alternatively melted and attached to an article, it would be possible to select a type of the sheet member 9 which allows smoother melt-based attachment adapted for material of the article.

In a technical field of composite stringer produced based on combination of resin-extruding and die wheel, it has been conducted by skilled person that the sheet member 9 is selectively introduced in the tape portion 3 considering influence to molding of fastening portion 4 or obeying the conventional practice (this is particularly true in patent literature 1). In such a conventional practice particularly where the sheet member 9 modifies a surface of composite stringer 2, only the surface of tape portion 3 is selectively modified by the sheet member 9, resulting in difference in appearance or surface condition between the tape portion 3 and the fastening portion 4. Additionally, this results in difference in softness or mechanical strength. The present disclosure allows reduction or cancellation of such a difference.

Various manners may be embodied where the respective ones of the tape portion 3 and the fastening portion 4 include the sheet member 9. A manner of inclusion of the sheet member 9 in the tape portion 3 and a manner of inclusion of the sheet member 9 in the fastening portion 4 are not necessarily the same but it is envisioned that they are different. This is because there is a possibility that, while a fastening portion is molded by a die wheel, flection or break is locally caused in the sheet member 9 due to contact with the die wheel.

Typically, in the tape portion 3, a resin layer and the sheet member 9 of the tape portion 3 are in an embedded, impregnated or laminated relation and similarly, in the fastening portion 4, a resin portion and the sheet member 9 of the fastening portion 4 are in the embedded, impregnated or laminated relation (the sheet member 9 is broken in the fastening portion 4 in an exemplary embodiment). The resin layer and the resin portion described herein indicate a portion made of resin of raw material (i.e. extruder-originated resin) other than the sheet member 9 of the composite stringer 2.

In some cases, in the tape portion 3 and/or in the fastening portion 4, the sheet member 9 is embedded in the resin, and the sheet member 9 is not directly exposed on the first and the second faces 73m, 73n of the composite stringer 2.

For example, the resin permeates into and through the sheet member 9, thereby the sheet member 9 is buried in the resin. As the sheet member 9 is embedded in the resin of the composite stringer 2, the surface condition of the composite stringer 2 may change. For example, in cases where the sheet member 9 is a woven fabric, knitted fabric or mixture thereof, the surface condition of the composite stringer 2 differs from a case where the sheet member 9 is omitted and a pattern in accordance with the sheet member 9 (e.g. woven pattern or knitted pattern or the combination thereof) emerges and is observable, as a result of permeation of the resin into the structure of the sheet member 9 (e.g. interstices defined between threads such as warp thread, weft thread or knitting yarn). A case is envisioned where such a pattern is not observed in one or both of top and bottom faces of the composite stringer 2 but is observed on a side face of the composite stringer 2.

In some cases, in the tape portion 3 and/or in the fastening portion 4, the sheet member 9 is impregnated with the resin. This encompasses a condition where the sheet member 9 and the resin are integrated as the resin permeates into the structure of the sheet member 9 (e.g. possible interstices between threads such as warp thread, weft thread or knitting yarn). In this case, the surface condition and appearance of the composite stringer 2 is substantially identical to the surface condition and appearance of the sheet member 9 but may be different from it due to influence of the resin inside of the sheet member 9. Note that, there is a benefit of waterproofness imparted to the tape portion 4 as the sheet member 9 is impregnated with the resin.

In some cases, the sheet member 9 and the resin layer are in laminated relation in the tape portion 3, and/or the sheet member 9 and the resin portion are in laminated relation in the fastening portion 4. The sheet member 9 is exposed on at least one face of the composite stringer 2, and the surface condition and appearance of the composite stringer 2 is substantially identical to the surface condition and appearance of the sheet member 9. The surface condition and appearance of the composite stringer 2 at the other face of the composite stringer 2 would be a resin surface of the resin layer or the resin portion. In this resin surface either, the pattern in accordance with the sheet member 9 may be observable. Note that, it would be possible to configure the composite stringer 2 by interposing the resin layer between two sheet members 9 so as to expose the sheet members 9 on both sides of the composite stringer 2.

Various embodiments are envisaged where the sheet member 9 is included in the fastening portion 4. It is not a requisite that the sheet member 9 or its broken piece(s) (e.g. fiber (a single fiber, a bundle of fibers and the like) of the structure) is included in every portion of the bottom plate 7g, the sidewall plate 7p,7q and the partition wall 7j of the groove 7, but it may be included in one or any combination of them. It is not a requisite that the sheet member 9 or its broken piece(s) is included in every fastening element 5 of the fastening portion 4, but it may be included in one or two or more fastening elements 5. It is also envisioned that the sheet member 9 exists selectively in the groove 7 only or in the fastening elements 5 only.

As seen in FIG. 3, the respective broken pieces of the sheet member 9 included in different fastening elements 5 (adjacent fastening elements 5 in the left-right direction in FIG. 3) may be positioned in or nearby a common plane. The sheet member 9 may be broken during the molding of the fastening portion 4 as spaces are formed between the fastening elements 5. However, these broken pieces are originally different portions of a same sheet member 9, and may be positioned in or nearby a common plane even after the molding. Of course, it is envisioned that the broken pieces exist at completely different heights even in the adjacent fastening elements 5 owing to extruding pressure and speed of resin, or rotational speed of die wheel.

Preferably, the sheet member 9 is made of porous material (i.e. resin-penetratable or permeable material) which allows permeation of resin into or through the sheet member 9. It should be noted that, even if a sheet member 9 does not have such resin-penetratable or resin-permeable characteristic, it would be possible to impart resin-permeable characteristic to the sheet member 9 by forming a series of holes in the sheet member 9. Additionally to the above-described woven fabric, knitted fabric and the mixture thereof, a sheet member 9 may be a resin sheet used for heat sealing, a foam layer or a paper. Note that number of the sheet member 9 in the composite stringer 2 is not limited to one but may be two or more. The sheet member 9 is not limited to a single layer sheet but may be a laminate sheet. For example, the sheet member 9 is a laminate sheet in which a coating film is formed on a woven fabric.

Hereinafter, an apparatus and method for production of composite stringer 2 would be discussed with reference to FIGS. 6-15. Apparatus for production of composite stringer 2 has a first die wheel 10, a second die wheel 20, an extruder 90, a guide rod 51, and a guide roll 30. The first die wheel 10 is secured to a rotational axis of motor (not illustrated) and rotates counterclockwise centered about the rotational axis. The second die wheel 20 is secured to a rotational axis of motor (not illustrated) and rotates clockwise (i.e. in a direction opposite to the rotational direction of the first die wheel) centered about the rotational axis. As a result, a material (particularly a resin) supplied into an interspace between the first die wheel 10 and the second die wheel 20 can be compressed between the both wheels. Minimum interspace may be set between the first and second die wheels 10 and 20 to allow the tape portion 3 of the composite stringer 2 to have a predetermined thickness. That is, the tape portion 3 may have a thickness substantially equal to the minimum interspace set between the first and second die wheels 10 and 20. For a purpose of appropriately positioning the second die wheel 20 relative to the first die wheel 10, a control mechanism may be employed that regulates a position of the rotational axis of the second die wheel 20 relative to the first die wheel 10.

The extruder 90 extrudes a resin onto a circumferential surface 11 of the first die wheel 10 (into the interspace between the first and second die wheels 10 and 20 here). The extruder 90 has a screw (not-illustrated), and discharges the resin 1 via its discharging mouth 91 (typically toward a ground side in a vertical direction) as the screw rotates. The resin 1 may be discharged as a resin layer having a predetermined width (a width equal to a total width of first and second molding belts described below or equal to or greater than a multiple of the total width). The resin 1 may be formed as a resin portion substantially layered on a predetermined area (e.g. an area having an angular range of 150-210°) of the circumferential surface 11 along the circumferential direction of the first die wheel 10.

Simultaneously as supplying the resin 1 onto the circumferential surface 11 of the first die wheel 10 (into the interspace between the first and second die wheels 10 and 20 here), the sheet member 9 is fed onto the circumferential surface 11 of the first die wheel 10 (into the interspace between the first and second die wheels 10 and 20 here). The resin 1 and the sheet member 9 are supplied onto the circumferential surface of the first die wheel 10 in a manner that they are stacked thereon and as a result, the composite stringer 2 is formed. The sheet member 9 has a width that is equal to a total width of first and second molding belts described below or equal to or greater than a multiple of the total width.

Whether the sheet member 9 and the resin 1 are in embedded, impregnated or laminated relation may depend on a material of the sheet member 9, an amount of supplied resin per unit time, cavity structures of the first and second die wheels 10 and 20 and the like. In some cases, in a primary molded part 8 (similarly each composite stringer 2 therein), a first region of the sheet member 9 is at least partially embedded in the resin layer of the tape portion 3, or the first region of the sheet member 9 is impregnated with the resin of the tape portion 3 or the first region of the sheet member 9 is laminated onto a resin layer of the tape portion 3. At least a part of a second region of the sheet member 9 or broken piece of the sheet member 9 may be embedded in the resin portion of the fastening portion 4; or at least a part of a second region of the sheet member 9 or broken piece of the sheet member 9 may be impregnated with the resin of the fastening portion 4; or a second region of the sheet member 9 or broken piece of the sheet member 9 may be laminated onto a resin portion of the fastening portion 4. The second region of the sheet member 9 may be a region directly adjacent to the first region of the sheet member 9. A part of the second region of the sheet member 9 may be positioned in the side-edge portion of the fastening portion 4 distal to the tape portion 3, and a part of the second region of the sheet member 9 may be exposed in the side-edge portion (e.g. side face) or a pattern in accordance with the sheet member 9 may emerge and be observable in the side-edge portion (e.g. side face).

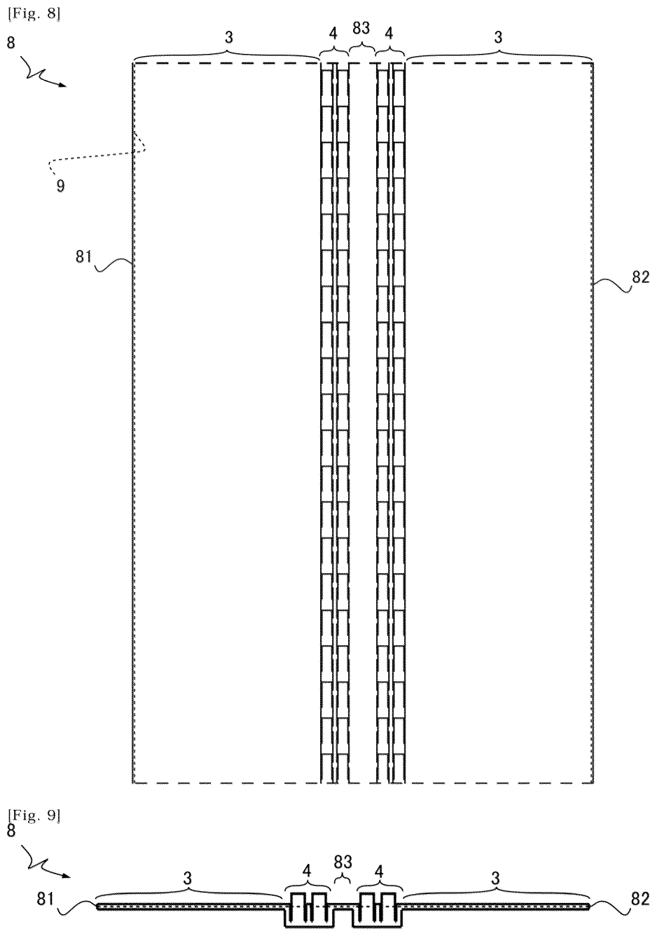

The apparatus for producing composite stringer 2 produces a primary molded part 8 made of one composite stringer 2 or a primary molded part 8 including plural composite stringers 2. In a case shown in FIGS. 8 and 9, a primary molded part 8 is produced where the composite stringers 2 are interconnected in a width direction. In this primary molded part 8, a tape portion 3, a fastening portion 4, a coupling portion 83, a fastening portion 4, and a tape portion 3 are arranged in this order in the width direction. Two composite stringers 2 would be obtained by cutting out or by splitting in and along the coupling portion 83 of the primary molded part 8. The two fastening portions 4 are located in the center area of the first and second die wheels 10,20 in the width direction, and thus defective molding (e.g. sink mark) of the fastening elements 5 is suppressed compared with a case where the fastening portions 4 are located in the side area of the primary molded part 8 in the width direction.

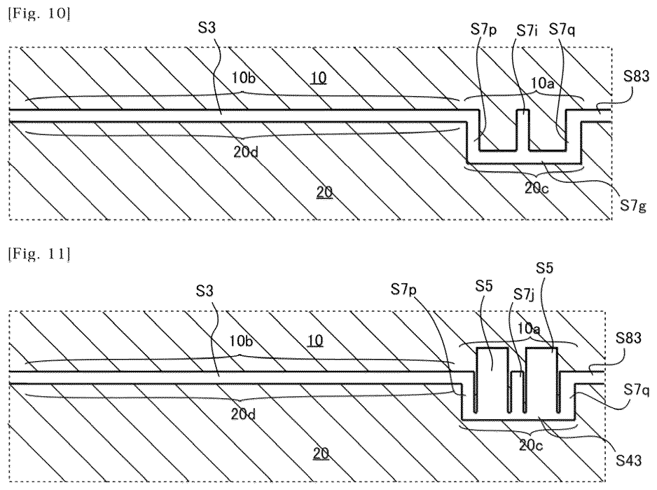

The sheet member 9 may be arranged in the entire width of the primary molded part 8. This avoids a burden of supplying sheet members 9 respectively for composite stringers 2, and the efficiency of production of composite stringer 2 would be enhanced. Note that, the primary molded part 8 has a first side edge 81 and a second side edge 82 in its width direction, by which a width thereof is Descriptions follows with reference to FIGS. 10-12. The circumferential surface 11 of the first die wheel 10 includes first and second molding belts 10a, 10b which are adjacent in the width direction of the first die wheel 10 and extend in the circumferential direction of the first die wheel 10. The width direction of the first die wheel 10 is a direction parallel to the rotational axis of the first die wheel 10. The first molding belt 10a is adapted for molding the fastening portion 4 (more particularly is shaped to have a molding surface that (at least partially) define mold cavities for the fastening elements 5), and the second molding belt 10b is adapted for molding or forming the tape portion 3 (more particularly is shaped to have a molding surface that (at least partially) define a mold cavity for the tape portion (or to have a flat surface that is parallel to the rotational axis of the first die wheel 10). The circumferential surface 21 of the second die wheel 20 includes a third molding belt 20c which is adapted for molding the fastening portion 4 together with the first molding belt 10a of the first die wheel 10 (more particularly is shaped to have a molding surface that (at least partially) define a mold cavity for the box portion 41). The circumferential surface 21 of the second die wheel 20 includes a fourth molding belt 20d adapted to mold the tape portion 3 together with the second molding belt 10b of the first die wheel 10 (more particularly is shaped to have a molding surface that (at least partially) define a mold cavity for the tape portion (or to have a flat surface that is parallel to the rotational axis of the second die wheel 20).

The first molding belt 10a includes molding cavities S5 adapted for molding the respective fastening elements 5. The first molding belt 10a also includes molding cavity S7j adapted for molding the partition wall 7j. The third molding belt 20c includes a molding cavity S41 adapted for molding the box portion 41.

The third molding belt 20c may include protrusions 22 for molding the clearance grooves 42. The second molding belt 10b and the fourth molding belt 20d are opposed to define a molding space S3 for molding the tape portion 3. Recess cavity may be provided in one or both of the second and fourth molding belts 10b and 20d to increase a thickness of the tape portion 3.

Note that there are sets of first to fourth molding belts 10a, 10b,20c,20d on the both sides of a molding cavity S83 for molding the coupling portion 83 in the primary molded part 8, but only one set is illustrated in FIGS. 10 and 11 for the sake of convenience of illustration. That is, the circumferential surface 11 of the first die wheel 10 includes a first belt including the first and second molding belts 10a and 10b, and a second belt including further first molding belt with a molding surface identically configured as the first molding belt 10a and a further second molding belt with a molding surface identically configured as the second molding belt 10b. The first molding belt 10a and the further first molding belt are spatially connected via the molding cavity S83. The circumferential surface 21 of the second die wheel 20 includes a further third molding belt with a molding surface identically configured as the third molding belt and a further fourth molding belt with a molding surface identically configured as the fourth molding belt. There further third and fourth molding belts are adapted to mold the fastening portion and the tape portion together with the further first and second molding belts of the first die wheel 10. The resin 1 is filled between the first and second die wheels 10 and 20 (into a space defined by the first to fourth molding belts, a space defined by the further first to fourth molding belts, and the molding cavity S83), and subsequently solidifies as being cooled in air or water and the like. As such the resin 1 is molded into a shape in accordance wit those molding belts.

In the present embodiment, the sheet member 9 is fed onto the circumferential surface 11 of the first die wheel 10 (e.g. into the interspace between the first and second die wheels 10 and 20) so as to at least partially cover the respective ones of the first and second molding belts 10a, 10b and so as to cross a boundary between the first and second molding belts 10a, 10b. As a result, the surface of the composite stringer 2 is modified not only in the tape portion 3 but also in the fastening portion 4, reducing a difference in appearance or surface condition between the tape portion 3 and the fastening portion 4. The sheet member 9 is included in the fastening portion 4 either and as a result, difference in softness and/or mechanical strength between the tape portion 3 and the fastening portion 4 may also be reduced. In cases where the second die wheel 20 is used, the sheet member 9 is supplied onto the circumferential surface 11 of the second die wheel 20 (e.g. into the interspace between the first and second die wheels 10 and 20) so as to cover the third and fourth molding belts 20c,20d additionally.

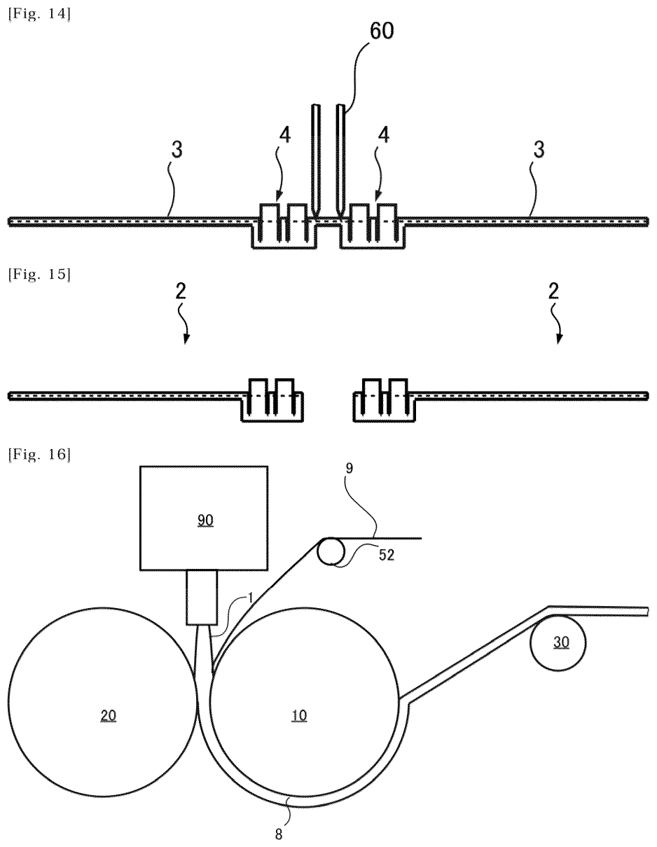

The primary molded part 8 has a surface condition or appearance in accordance with the sheet member 9 (e.g. see FIG. 13). In FIG. 13, the sheet member 9 is a woven web, and a woven pattern in accordance with the warp and weft threads emerges on one or both sides of the primary molded part 8. Note that the instant figure depicts only one side of the primary molded part 8, but a pattern in accordance with the sheet member 9 emerges also on the other side. A case where the sheet member 9 is a knitted fabric would be similarly understandable. In a case where the sheet member 9 is not supplied, the composite stringer 2 would have resin surfaces only. As the composite stringer 2 includes the sheet member 9, the surface condition or appearance of the composite stringer 2 can be modified. In particular, the sheet member 9 is included in both of the tape portion 3 and the fastening portion 4. In FIG. 13, a pattern in accordance with the sheet member 9 is not illustrated in the box portions 41, but a pattern similar to one in the tape portion 3 may emerge or a broken piece of the sheet member 9 may be contained therein. Alternatively, there is a case as shown in FIG. 13 where the pattern in accordance with the sheet member 9 does not emerge on the surface of the box portion 41 but emerges between adjacent box portions 41. As a result of this, the composite stringer 2 may have a surface condition or appearance in accordance with the sheet member 9 on the both sides of the boundary between the tape portion 3 and the fastening portion 4 at least on one face thereof (preferably on the both faces thereof). In cases where the sheet member 9 has resin-penetratable or resin-permeable characteristic, the resin 1 permeates into and through the sheet member 9, and the fastening elements 5 or the box portions 41 can be molded as intended.

In cases where the primary molded part 8 includes a single composite stringer 2, the primary molded part 8 may be cut to have a desired length so that a composite stringer 2 of the desired length is obtained. In cases where the primary molded part 8 includes plural composite stringers 2, a cutter 60 is used to cut out the coupling portion 83 or to form a cut line in and along the coupling portion 83 so that the respective composite stringers 2 can be obtained from the primary molded part 8 as appreciated from FIGS. 14 and 15. The cutter 60 may be arranged at the side of the second face of the primary molded part 8. Due to the cutting of the above-described primary molded part 8, the sheet member 9 may be exposed at a side face of the composite stringer 2 (along the elongation direction or the width direction). Note that when the cutting line is formed in the coupling portion 83, a part of the coupling portion 83 connected to the sidewall plate 7q may remain as one side-edge portion of the composite stringer 2. Two composite stringers 2 obtained through cutting as shown in FIGS. 14 and 15 are stacked on top of each other such that the fastening elements 5 of the respective composite stringers 2 are opposed, thereby configuring the fastening device 100.

As understood from the above descriptions, a method of producing a composite stringer disclosed in the present specification includes: (i) an extruder extruding a soft or molten resin toward a circumferential surface of die wheel and supplying the resin on the circumferential surface of the die wheel; and (ii) feeding at least one sheet member onto the circumferential surface of the die wheel simultaneously as supplying the resin onto the circumferential surface of the die wheel. In a case where a pair of die wheels is used, the resin and the sheet member are supplied to an interspace between them. In either way, the sheet member is fed onto the circumferential surface of the die wheel so as to at least partially cover the respective ones of the first and second molding belts and to cross a boundary between the first and second molding belts. As a result, the composite stringer may have, on at least one face thereof, a surface condition or appearance in accordance with the sheet member on the both sides of the boundary between the tape portion and the fastening portion.

Supply pressure, supply amount per unit time, coefficient of viscosity, temperature and the like of the resin 1 would be properly determined by a skilled person in the art. Transfer speed of the sheet member 9, tension applied to the sheet member 9 and the like would also be properly determined by a skilled person in the art. Rotational speeds of the first and second dies 10 and 20, a distance between them and the like would also be properly determined by a skilled person in the art. Note that the transfer speed of the sheet member 9 is not necessarily equal to the speed of extruding of the resin 1, and may be faster in some cases. The primary molded part 8 may be cooled by air or water at a position vertically under the first die wheel 10. Accordingly, the primary molded part 8 is prevented or suppressed from deforming when delaminated from the first die wheel 10.

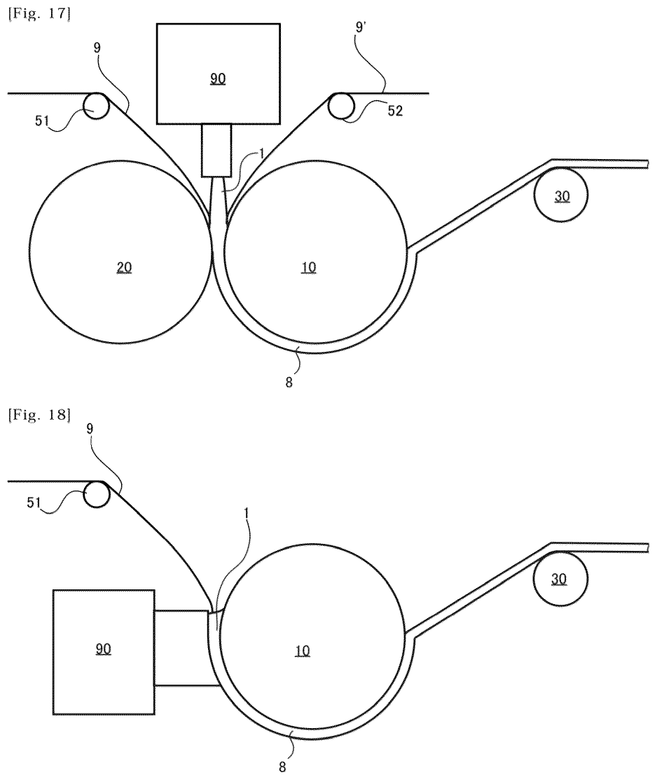

Unlike FIG. 7, the sheet member 9 may be fed from a side of the fist die wheel 10 as shown in FIG. 16. The sheet member 9 used has resin-penetratable or resin-permeable characteristic. The resin 1 may flow into the respective molding cavitys of the first and second molding belts 10a and 10b through the sheet member 9. As shown in FIG. 17, first and second sheet members 9 may be respectively fed from the sides of the first and second die wheels 10 and 20.

One composite stringer 2 may include two sheet members 9 corresponding to the top and bottom faces of the composite stringer 2. This brings the surface texture at the both top and bottom faces of the composite stringer 2 closer to the surface texture of the sheet member 9. In this case, the resin permeates into and through the respective sheet members 9 and a resin layer may be formed between the sheet members 9 (3 layer structure may be formed in the tape portion 3 which includes the sheet member impregnated with the resin, the resin layer, and another sheet member impregnated with the resin). As shown in FIG. 18, the discharging mouth of the extruder 90 may be arranged to confront the circumferential surface 11 of the first die wheel 10, and the sheet member 9 may be fed to the interspace between the first die wheel 10 and the discharging mouth of the extruder 90.

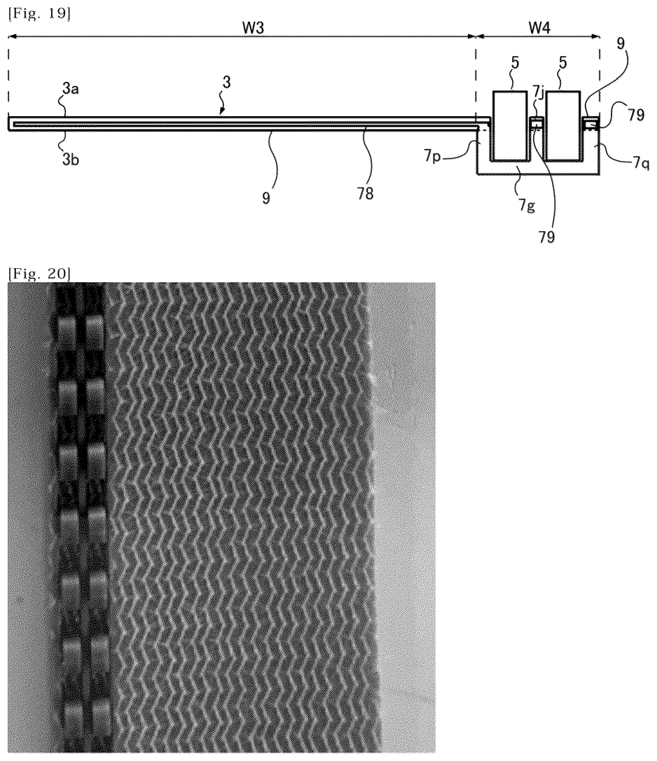

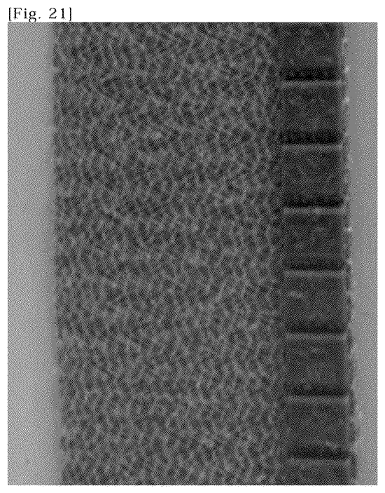

Further description follows by way of precaution. FIG. 3 depicts that the sheet member 9 is embedded in the resin layer of the tape portion 3 and the resin portion of the fastening portion 4. However, if the sheet member 9 is thick as shown in FIG. 19, an embodiment is envisaged where the sheet member 9 is impregnated with the resin (or a resin layer 78 is embedded in the sheet member 9) in the tape portion 3, and the sheet member 9 is impregnated with the resin (or a resin portion 79 is embedded in the sheet member 9) in the fastening portion 4. If the sheet member 9 is broken when compressed between the first and second die wheels 10 and 20, a broken piece of the sheet member 9 may be contained in the resin portion of the fastening portion 4 (e.g. fastening element 5 or groove 7 or box portion 41). Advantageously, the resin portion of the fastening portion 4 may have an appearance similar to the appearance of the tape portion 3.

### Working Example 1

The apparatus for production shown in FIG. 17 was used to produce the primary molded part 8 shown in FIGS. 8 and 9. Next, the primary molded part is cut as shown in FIG. 14, and the respective composite stringers are obtained and are cut to have desired length. A knitted fabric was employed as the sheet member. The composite stringer obtained as such had a first tape face where a pattern in accordance with the knitted fabric as shown in FIG. 20 emerged. Similarly, on the second tape face of the composite stringer, a pattern in accordance with the knitted fabric as shown in FIG. 21 emerged and further a raised nap, originating from fibers of the knitted fabric, emerged. In particular, a pattern in accordance with the knitted fabric was observable in the both of the tape portion and the fastening portion. A pattern in accordance with the knitted fabric was observable also in the side-edge portion of the fastening portion of the composite stringer. A pattern in accordance with the knitted fabric was observable also in the bottom surface of the groove between the fastening elements along the elongation direction or in the sidewall surface thereof. Fibers, originating from the knitted fabric, were observable on the box portion (particularly the main surface thereof). One or any combination of the above-noted results of observation would be understandable as distinctive features originating from the presently disclosed method of production (without requiring association with other features of the present disclosure).

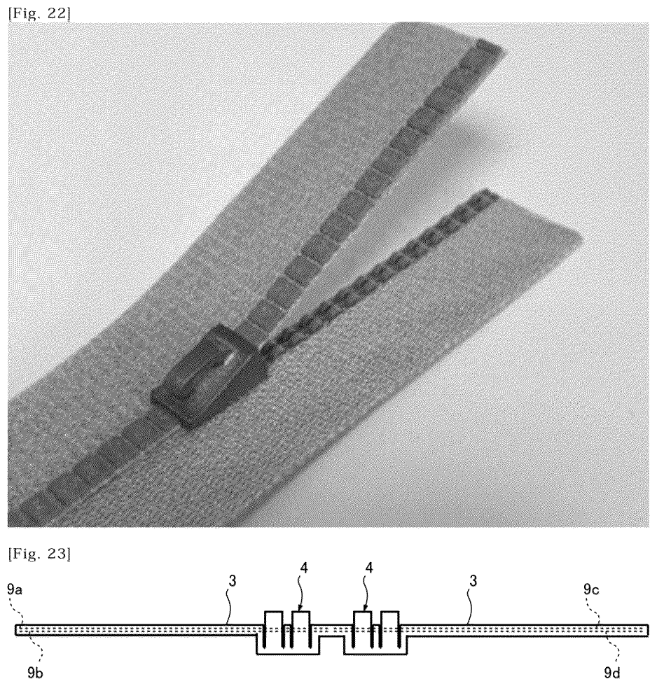

FIG. 22 presents a photograph of fastening device in which a slider is attached to a pair of composite stringers. The composite stringer 2 has a texture alike the texture of the sheet member 9 in both of the tape portion 3 and the fastening portion 4, unlike resin surface with inorganic appearance.

FIG. 23 depicts an embodiment where the primary molded part 8 includes 4 sheet members 9 in accordance the method shown in FIG. 17. In the present embodiment, the sheet member 9a-9d each includes woven and/or knitted structure, and has different appearances on the both top and bottom faces thereof. When used as the fastening device 100, one composite stringer 2 is reversed relative to the other one for use. In the present embodiment, the sheet members 9 which are in upside down relationship are included in each composite stringer 2 used for the pair so as to avoid that difference in appearance between the top and bottom faces of the sheet member 9 causes a difference in appearance of the left and right composite stringers 2 of the fastening device 100. For example, the sheet member 9d is upside down relative to the sheet member 9a. When the primary molded part 8 of FIG. 23 is cut into left and right composite stringers 2 and these are coupled, the sheet member 9d is reversed and the bottom surface of the sheet member 9d would be the top surface. As a result, difference in appearance between the left and right composite stringers 2 is reduced in the fastening device 100. Additionally or alternatively to the reversed relationship between the sheet members 9a and 9d, the sheet member 9c may be reversed upside down relative to the sheet member 9b. Also, in stead of reversing the sheet member 9 upside down with respect to the top and bottom faces of the primary molded part 8, a direction of protruding of the engagement protrusion 5b may be reversed between one fastening portion 4 and the other fastening portion 4 in the primary molded part 8.

Based on the above teachings, a skilled person in the art would be able to add various modifications to the respective embodiments. Reference codes in Claims are just for reference and should not be referred for the purpose of narrowly construing the scope of claims. Boundary between the fastening portion and the tape portion encompasses both of a boundary line and a boundary area (e.g. another functional area).

### REFERENCE CODE

2: Composite stringer
3: Tape portion
3a: First tape face
3b: Second tape face
4: Fastening portion
5: Fastening element
5a: Stem
5b: Engagement protrusion
6: Gap
7: Groove
7a: Bottom surface
9: Sheet member
10: First die wheel
10a: First molding belt
10b: Second molding belt
11: Circumferential surface
12: Circumferential surface
20: Second die wheel
20c: Third molding belt
21: Circumferential surface
22: Protrusion
41: Box portion
78: Resin layer
79: Resin portion

1. A method of producing a composite stringer (2) including at least a tape portion (3) and a fastening portion (4), the method including:
supplying a soft or molten resin (1) onto a circumferential surface of a die wheel (10), the circumferential surface of the die wheel (10) including first and second molding belts (10a, 10b) adjacent in a width direction of the die wheel (10) and extending in a circumferential direction of the die wheel (10), the first molding belt (10a) being adapted to mold a fastening portion (4) including at least plural fastening elements (5), the second molding belt (10b) being adapted to mold or form the tape portion (3); and
feeding at least one sheet member (9) onto the circumferential surface of the die wheel (10) simultaneously as said supplying of the resin (1) onto the circumferential surface of die wheel (10), the sheet member (9) being fed onto the circumferential surface of the die wheel (10) so as to overlap at least partially the respective ones of the first and second molding belts (10a, 10b) and to cross a boundary between the first and second molding belts (10a, 10b) so that the composite stringer (2) has a surface condition or appearance in accordance with the sheet member (9) on both sides of the boundary between the tape portion (3) and the fastening portion (4).

2. The method of producing a composite stringer of claim 1 wherein the resin (1) and the sheet member (9) are supplied into an interspace between a pair of die wheels (10,20) including said die wheel (10) as a first die wheel (10).

3. The method of producing a composite stringer of claim 2 wherein a circumferential surface of a second die wheel (20) of the pair of die wheels (10,20) includes a third molding belt (20c) adapted to mold the fastening portion (4) together with the first molding belt (10a) of the first die wheel (10).

4. The method of producing a composite stringer of claim 3 wherein the sheet member (9) is made of porous material allowing penetration or permeation of the resin (1) through the at least one sheet member (9), allowing the resin (1) to flow between the first molding belt (10a) and the third molding belt (20c).

5. The method of producing a composite stringer of any one of claims 1 to 4 wherein the sheet member (9) has a width equal to or wider than a total width of the first and second molding belts (10a, 10b).

6. The method of producing a composite stringer of any one of claims 1 to 5 wherein the resin (1) and the sheet member (9) are supplied onto the circumferential surface of the die wheel (10) so as to allow a structure of the sheet member (9) to be observable in one or both of top and bottom faces or a side face of the composite stringer (2).

7. The method of producing a composite stringer of any one of claims 1 to 6 wherein the resin (1) and the sheet member (9) are supplied onto the circumferential surface of the die wheel (10) so that:
(i) a first region of the sheet member (9) is enclosed at least partially in a resin layer (78) of the tape portion (3), or a first region of the sheet member (9) is impregnated with a resin of the tape portion (3), or a first region of the sheet member (9) is laminated to a resin layer (78) of the tape portion (3); and
(ii) a second region of the sheet member (9) or a broken piece of the sheet member (9) is at least partially enclosed in a resin portion (79) of the fastening portion (4), or a second region of the sheet member (9) or a broken piece of the sheet member (9) is impregnated with a resin of the fastening portion (4), or a second region of the sheet member (9) or a broken piece of the sheet member (9) is laminated to a resin portion (79) of the fastening portion (4).

8. The method of producing a composite stringer of any one of claims 1 to 7 wherein the composite stringer (2) has a pair of side-edge portions (71a,72a) extending along its elongation direction, and the resin (1) and the sheet member (9) are supplied onto the circumferential surface of the die wheel (10) so as to allow at least one of the pair of side-edge portions (71a,72a) to have a surface condition or appearance in accordance with the sheet member (9).

9. The method of producing a composite stringer of any one of claims 1 to 8 in which the circumferential surface of the die wheel (10) include a first belt including the first molding belt (10a) and the second molding belt (10b), and a second belt including a further first molding belt and a further second molding belt, the further first molding belt having a molding surface configured identical to the first molding belt (10a), the further second molding belt having a molding surface configured identical to the second molding belt (10b), the method further including:
separating a first composite stringer (2) molded in the first belt and a second composite stringer (2) molded in the second belt.

10. A composite stringer (2) comprising:
a tape portion (3);
a fastening portion (4); and
at least one sheet member (9), wherein
each of the tape portion (3), the fastening portion (4) and the sheet member (9) extend in an elongation direction of the composite stringer (2), and the tape portion (3) and the fastening portion (4) are arranged adjacently, and wherein
the sheet member (9) is included in respective ones of the tape portion (3) and the fastening portion (4), and
the composite stringer (2) has a surface condition or appearance in accordance with the sheet member (9) on both sides of a boundary between the tape portion (3) and the fastening portion (4).

11. The composite stringer of claim 10 wherein a first region of the sheet member (9) is enclosed at least partially in a resin layer (78) of the tape portion (3), or a first region of the sheet member (9) is impregnated with a resin of the tape portion (3), or a first region of the sheet member (9) is laminated to a resin layer (78) of the tape portion (3).

12. The composite stringer of claim 10 or 11 wherein at least a part of a second region of the sheet member (9) or a broken piece of the sheet member (9) is enclosed in a resin portion (79) of the fastening portion (4), or a second region of the sheet member (9) or a broken piece of the sheet member (9) is impregnated with a resin of the fastening portion (4), or a second region of the sheet member (9) or a broken piece of the sheet member (9) is laminated to a resin portion (79) of the fastening portion (4).

13. The composite stringer of any one of claims 10 to 12 wherein a part of the second region of the sheet member (9) is positioned in a side-edge portion of the fastening portion (4) distal to the tape portion (3).

14. The composite stringer of any one of claims 10 to 13 wherein the fastening portion (4) encloses a part of the sheet member (9) or a broken piece of the sheet member (9); and/or a structure of the sheet member (9) is observable in one or both of top and bottom faces or a side face of the composite stringer (2).

15. The composite stringer of any one of claims 10 to 14 wherein the fastening portion (4) includes a groove (7) extending in the elongation direction so as to form a box portion (41) on a side of one tape face of the tape portion (3), and a series of fastening elements (5) in which the fastening elements (5) are arranged on a bottom surface of the groove (7) along the elongation direction and gaps (6) are formed between adjacent fastening elements (5), each fastening element (5) including a stem (5a) standing on the bottom surface of the groove (7) along a thickness direction of the tape portion (3) and an engagement protrusion (5b) protruding from the stem (5a) in the elongation direction.
